(19) United States
(12) Patent Application Publication
(10) Pub. No.: US 2018/0336447 A1
(43) Pub. Date: Nov. 22, 2018

(54) MULTIPLE CODES IN AN ARRAY PATTERN WITH SPARSE DISTRIBUTION OF MICROPARTICLES

(71) Applicant: TruTag Technologies, Inc., Kapolei, HI (US)

(72) Inventors: Hod Finkelstein, Berkeley, CA (US); Sergey Etchin, Castro Valley, CA (US)

(21) Appl. No.: 15/979,106

(22) Filed: May 14, 2018

Related U.S. Application Data
(60) Provisional application No. 62/508,303, filed on May 18, 2017.
(60) Provisional application No. 62/508,304, filed on May 18, 2017.

(51) Int. Cl. G06K 19/06

(52) U.S. Cl. CPC G06K 19/06046

(57) ABSTRACT

A system for depositing tags in an array includes a substrate holder, a tag depositor, and a positioner. The substrate holder is configured to hold a substrate. The tag depositor is configured to deposit tags on the substrate. The positioner is configured to position the tag depositor relative to the substrate. The positioner positions the tag depositor to deposit tags on the substrate in an array

### CROSS REFERENCE TO OTHER APPLICATIONS

This application claims priority to U.S. Provisional Patent Application No. 62/508,303 entitled MULTIPLE CODES IN AN ARRAY PATTERN filed May 18, 2017 which is incorporated herein by reference for all purposes. This application also claims priority to U.S. Provisional Patent Application No. 62/508,304 entitled SPARSE DISPERSION OF MICROPARTICLES filed May 18, 2017 which is incorporated herein by reference for all purposes.

### BACKGROUND OF THE INVENTION

Spectral detection of optical tags utilizes optically coded tags including distinctive optical codes. Codes are implemented using a material that produces a set of reflective optical peaks. For example, the reflectivity of the material is encoded using a stack or using a smoothly varying change in optical index created by controlled etching of silicon wafers, (e.g., a rugate optical filter). Tags with distinct codes can be used to distinguish distinct products. The number of possible tag codes is limited, limiting the amount of information that it is possible to embed using the tags. For applications such as counterfeit detection or distinguishing distinct product stock keeping units, the limited number of codes is acceptable. However, a problem is created when individual products are to be distinguished, for instance when tags are desired to be used as serial numbers.

### BRIEF DESCRIPTION OF THE DRAWINGS

Various embodiments of the invention are disclosed in the following detailed description and the accompanying drawings.

FIG. 1 is a diagram illustrating an embodiment of a system for depositing tags in an array.

FIG. 2 is a diagram illustrating an embodiment of a system for sparse dispersion of tags.

FIG. 3A is a diagram illustrating an embodiment of tags in an array. Tag region array 300 comprises an array of regions for tag deposition.

FIG. 3B is a diagram illustrating an embodiment of tags in an array. Tag region array 310 comprises an array of regions for tag deposition.

FIG. 3C is a diagram illustrating an embodiment of tags in an array. Tag region array 320 comprises an array of regions for tag deposition.

FIG. 4 is a diagram illustrating an embodiment of a system for depositing tags.

FIGS. 5A-D are diagrams illustrating an embodiment of a system for depositing tags.

FIG. 6 is a flow diagram illustrating an embodiment of a process for depositing tags in an array.

FIG. 7 is a flow diagram illustrating an embodiment of a process for sparse dispersion of tags.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for depositing tags in an array is disclosed. The system comprises a substrate holder configured to hold a substrate, a tag depositor configured to deposit tags on the substrate, and a positioner configured to position the tag depositor relative to the substrate, wherein the positioner positions the tag depositor to deposit tags on the substrate in an array.

A system for depositing tags in an array comprises a substrate holder, a tag depositor, and a positioner. The substrate holder is configured to hold a substrate. For example, the substrate holder comprises a clamping substrate holder, a vacuum substrate holder, a belt substrate holder, etc. The tag depositor is configured to deposit tags on the substrate. In some embodiments, the tag depositor comprises one of a plurality of tag depositors. The positioner is configured to position the tag depositor relative to the substrate, wherein the positioner positions the tag depositor to deposit tags on the substrate in an array. The tag depositor moves relative to the substrate (e.g., in an array pattern) to deposit tags in an array. In various embodiments, the tag depositor is still and the substrate moves, the substrate is still and the tag depositor moves, or both the tag depositor and the substrate move to achieve appropriate positioning of the tags and the substrate. The tag depositor is coupled to a tag reservoir (e.g., the enclosure holding a set of tags) for providing tags. In some embodiments, the tag reservoir comprises one of a plurality of tag reservoirs, wherein a coupling to the tag depositor is switchable between the plurality of tag reservoirs. For example, the tag reservoirs of the plurality of tag reservoirs are associated with tags with distinct codes, allowing the tag depositor to deposit tags with distinct codes across the array. Alternatively, the tag depositors of the plurality of tag depositors are associated with tags with distinct codes, allowing the plurality of tag depositors to deposit tags with distinct codes across the array. A set of distinct tags deposited in an array can be read using a spatially localized spectral imaging system. The set of tag codes is interpreted as a single code word, with a large array of code words possible.

In some embodiments, the tag depositor comprises a system for sparse distribution of tags. The system for sparse dispersion of tags comprises an enclosure configured to contain a set of tags, wherein the set of tags settles to the bottom of the enclosure in a heap, an input tube configured to inject gas near the bottom of the enclosure, and an exit tube configured such that the distance to the set of tags in the heap generates a sparse flow of tags from the set of tags that exits the exit tube when a gas is injected via the input tube. The number of tags in the set of tags is limited to allow room between the top of the heap and the top of the enclosure. A gas (e.g., air) fills the enclosure between the top of the heap and the top of the enclosure. The system comprises an inlet tube entering the enclosure. The end of the inlet tube is near the bottom of the heap of tags. When a gas (e.g., air) is injected via the input tube, tags are pushed out of the heap and mix with the gas above the top of the heap. The number of tags in the heap, amount of room above the heap, and gas injection flow are chosen such that the tags are sparsely distributed within the gas above the top of the heap. The system additionally comprises an output tube for allowing the mixture of gas and tags to exit the enclosure. The exit tube is configured such that a distance to the set of tags in the heap generates a sparse flow of tags from the set of tags that exits the exit tube when a gas is injected via the input tube.

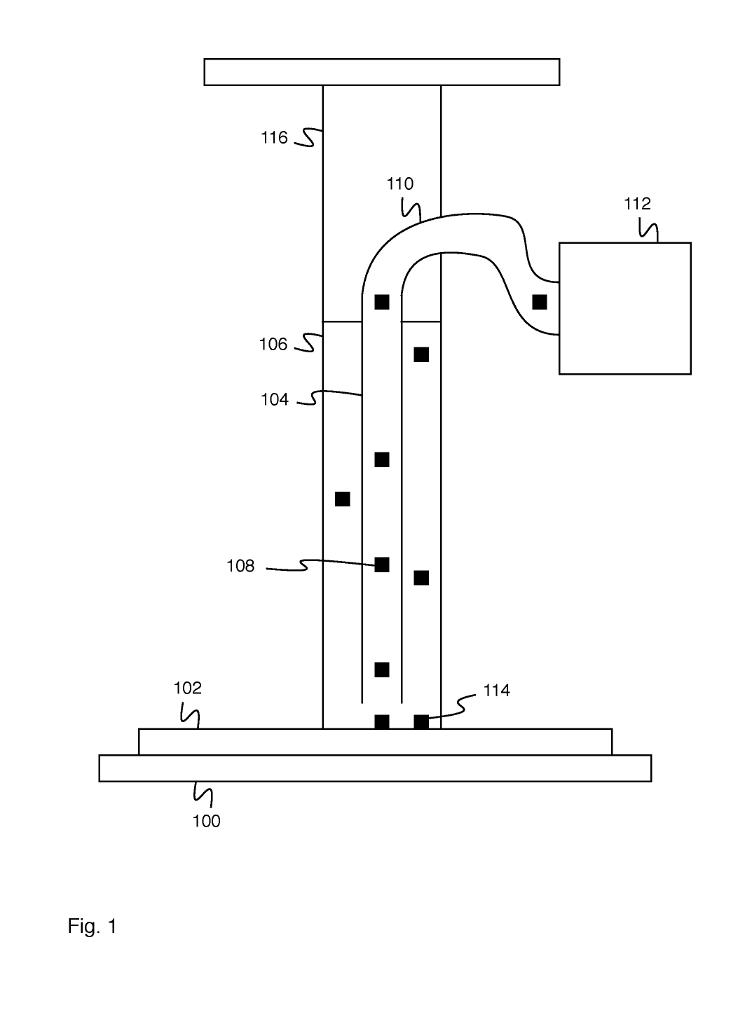

FIG. 1 is a diagram illustrating an embodiment of a system for depositing tags in an array. Substrate holder 100 comprises a substrate holder for holding substrate 102. Substrate 102 comprises a substrate for tagging—for example, cardboard or plastic packaging material. In the example shown, substrate 102 is flat. Substrate 102 comprises any appropriate flat or dimensional form factor (e.g., any surface of an object that it is desired tags be deposited on). Tube 104, and shroud 106 comprise a tag depositor. The tag depositor comprises a tag depositor for depositing tags on substrate 102. Tube 104 comprises a tube for conducting tags mixed in a gas (e.g., air) to substrate 102, and shroud 106 comprises a shroud for limiting the area of substrate 102 that the tags mixed with gas is able to contact. In some embodiments, tags 114 are removed by drawing them up into the top of shroud 106. In various embodiments, tube 104 comprises a syringe, a pipette, a needle valve, or any other appropriate tube. Tag source 112 comprises a tag source for providing a sparse mixture of tags in gas. In some embodiments, tag source 112 comprises a system for sparse dispersion of tags. Tags provided by tag source 112 comprise identical tags (e.g., tags all associated with the same tag code). Tag source 112 is coupled to tube 104 with coupling 110. Tags (e.g., tag 108) flow out from tag source 112 and occupy coupling 110, tube 104, and shroud 106. Some tags (e.g., tag 114) deposit on the surface of substrate 102. Positioner 116 comprises a positioner configured to position the tag depositor relative to substrate 102, wherein the positioner positions the tag depositor to deposit tags on substrate 102 in an array. Positioner 116 comprises a positioner able to position the tag depositor in two dimensions relative to substrate 102 (e.g., to the left and right of the page, and into and out of the page). In some embodiments, part of a positioner of the system for depositing tags in an array is comprised by substrate holder 100. For example, substrate holder 100 comprises a belt capable of moving substrate 102 in one dimension.

In some embodiments, the system for depositing tags in an array comprises a plurality of tag sources. The individual tag sources are each associated with a different tag code (e.g., the tags provided by a single tag source comprise the same tag code, and different tag sources are associated with different tag codes). The coupling for coupling the plurality of tag sources to tube 104 comprises a switchable coupling for selecting a single tag source of the plurality of tag sources. The ability to select and deposit a tag code from a plurality of tag codes allows the system for depositing tags in an array to deposit tags of different codes at different locations in the array. A system for depositing tags in an array comprising a plurality of tag sources can additionally comprise a system for purging (e.g., clearing tags out of the tag depositor) prior to switching tag sources. For example, a system for purging comprises a vent for allowing gas mixed with tags to exit the tag depositor and a purge gas connection for allowing gas with no tags to enter the tag depositor.

In some embodiments, the system for depositing tags in an array comprises a plurality of tag depositors. The tag depositors of the plurality of tag depositors are coupled to one or more different tag sources, and each different tag source is associated with a different tag code. The plurality of tag depositors associated with one or more different tag sources allows the system for depositing tags in an array to deposit tags of different codes at different locations in the array. In some embodiments, a plurality of tag depositors is associated with a single code. In some embodiments, a plurality of tag depositors is arranged in an array with a fixed position relative to one another. In some embodiments, a plurality of tag depositors is arranged in a linear array.

Tags (e.g., tag 108, tag 114) comprise coded tags. In some embodiments, tags comprise optical interference filters (e.g., rugate filters or etched porous silicon filters). In some embodiments, tags comprise particles of less than 100 micrometers with embedded optically readable codes.

In various embodiments, a tag depositor deposits tags in a fluid or gel carrier, or any other appropriate carrier for tags. In the case in which the tag depositor utilizes a fluid or gel carrier, the depositor may not have shroud 106.

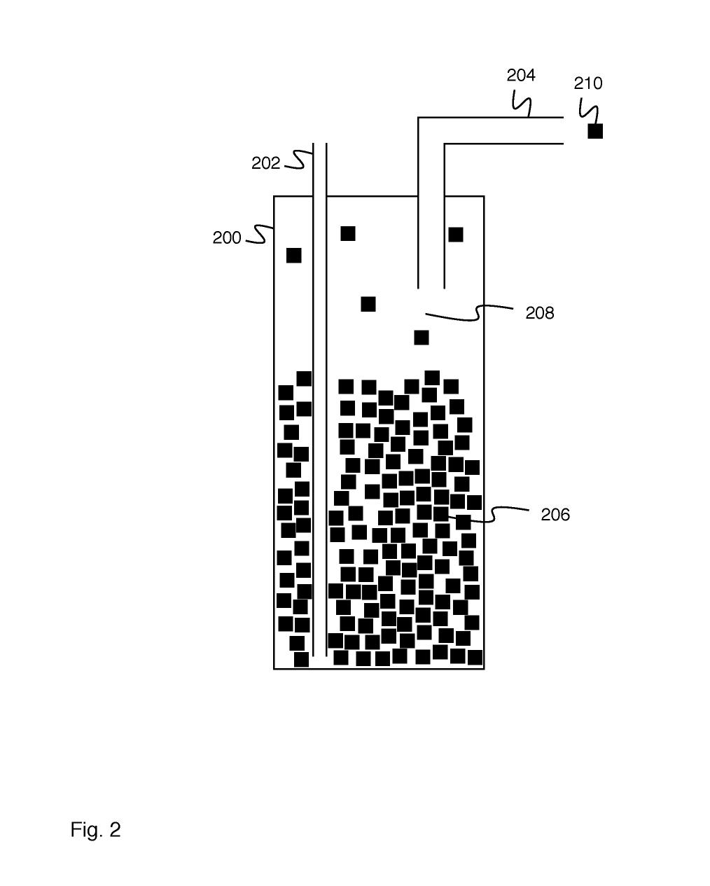

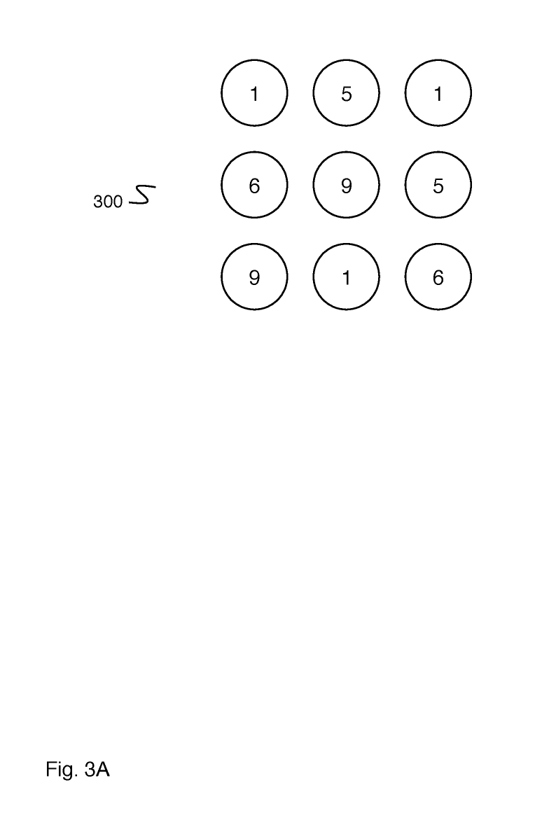

FIG. 2 is a diagram illustrating an embodiment of a system for sparse dispersion of tags. In some embodiments, the system for sparse dispersion of tags of FIG. 2 comprises tag source 112 of FIG. 1. In the example shown, the system for sparse dispersion of tags comprises enclosure 200. Enclosure 200 comprises an enclosure for holding tags. Enclosure 200 holds a set of tags (e.g., tag 206). The set of tags has settled to the bottom of enclosure 200 in a heap. Input tube 202 comprises an input tube for a gas (e.g., air) input into enclosure 200. Input tube 202 enters enclosure 200 at its top and ends near the bottom of enclosure 200. In some embodiments, near the bottom of enclosure 200 comprises near the bottom of the heap or at the bottom of the heap. The heap does not reach the top of enclosure 200, allowing gas region 208 to form. Gas region 208 comprises a mixture of tags and gas. Exit tube 204 reaches into enclosure 200 and ends within gas region 208. Exit tube 204 is configured such that the distance to the set of tags in the heap generates a sparse flow of tags from the set of tags that exits the exit tube when a gas is injected via the input tube. The distance to the set of tags in the heap comprises the distance between the inlet of the exit tube and a surface of the heap. When gas is injected via inlet tube 202 a suspension (e.g., an aerosol) of tags forms in gas region 208. The system for sparse dispersion of tags is designed (e.g., the volume of the heap of tags is chosen, the volume of enclosure 200 is chosen, and the inlet tube gas flow rate is chosen) such that a low-density aerosol forms. In some embodiments, the system is designed such that there is enough gas above the surface of the heap to create a low-density aerosol. In some embodiments, the system is designed such that the gas injected by the input tube is at a flow rate to force tags into the gas above the surface of the heap at an appropriate rate to create a low-density aerosol. Tags (e.g., tag 210) exit enclosure 200 through exit tube 204 in a sparse dispersion.

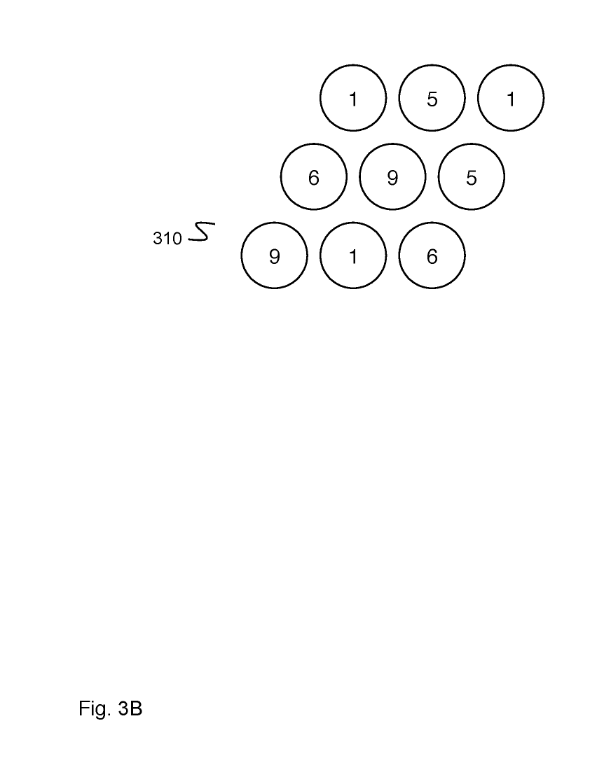

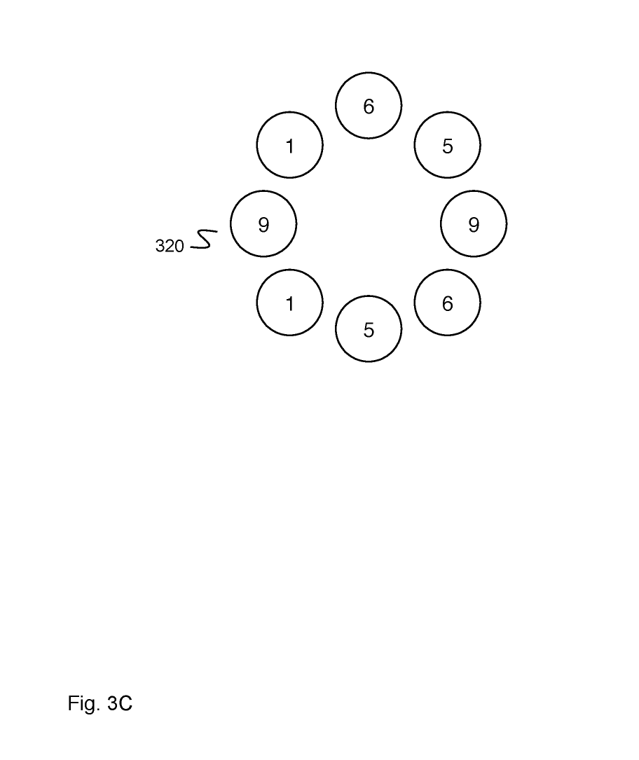

FIG. 3A is a diagram illustrating an embodiment of tags in an array. Tag region array 300 comprises an array of regions for tag deposition. In the example shown, tag region array 300 comprises 9 regions for tag deposition and tags comprising 4 different codes deposited in the regions for tag deposition. In some embodiments, the array of regions is N by M regions, where M and N are integers. Tags are deposited in the pattern indicated by tag region array 300 using a system for depositing tags in an array comprising a tag depositor and a plurality of tag sources; or using a system for depositing tags in an array comprising a plurality of tag depositors, each tag depositor associated with a tag source. In some embodiments, multiple tag depositors are associated with the same tag code. In some embodiments, a fiducial marker exists near tag region array 300 for aligning distinct tag deposition steps. The fiducial marker comprises a marker (e.g., affixed to the surface, printed on the surface, etched in the surface, etc.) with a location that can be accurately determined by a positioning system and used for alignment of tag deposition. Tag region array 300 comprises an orthogonal array.

FIG. 3B is a diagram illustrating an embodiment of tags in an array. Tag region array 310 comprises an array of regions for tag deposition. In the example shown, tag region array 310 comprises 9 regions for tag deposition and tags comprising 4 different codes deposited in the regions for tag deposition. In some embodiments, the array of regions is N by M regions, where M and N are integers. Tags are deposited in the pattern indicated by tag region array 310 using a system for depositing tags in an array comprising a tag depositor and a plurality of tag sources; or using a system for depositing tags in an array comprising a plurality of tag depositors, each tag depositor associated with a tag source. In some embodiments, multiple tag depositors are associated with the same tag code. In some embodiments, a fiducial marker exists near tag region array 310 for aligning distinct tag deposition steps. The fiducial marker comprises a marker (e.g., affixed to the surface, printed on the surface, etched in the surface, etc.) with a location that can be accurately determined by a positioning system and used for alignment of tag deposition. Tag region array 310 comprises a non-orthogonal array.

FIG. 3C is a diagram illustrating an embodiment of tags in an array. Tag region array 320 comprises an array of regions for tag deposition. In the example shown, tag region array 320 comprises 8 regions for tag deposition and tags comprising 4 different codes deposited in the regions for tag deposition. In various embodiments, the regions form a shape—for example, a line, a circle, an oval, a square, a rectangle, a curve, a freeform curved line, any two-dimensional array (e.g., an orthogonal array, a non-orthogonal array, etc.), or any other appropriate shape. Tags are deposited in the pattern indicated by tag region array 320 using a system for depositing tags in an array comprising a tag depositor and a plurality of tag sources; or using a system for depositing tags in an array comprising a plurality of tag depositors, each tag depositor associated with a tag source. In some embodiments, multiple tag depositors are associated with the same tag code. In some embodiments, a fiducial marker exists near tag region array 320 for aligning distinct tag deposition steps. The fiducial marker comprises a marker (e.g., affixed to the surface, printed on the surface, etched in the surface, etc.) with a location that can be accurately determined by a positioning system and used for alignment of tag deposition. Tag region array 320 comprises a circular array.

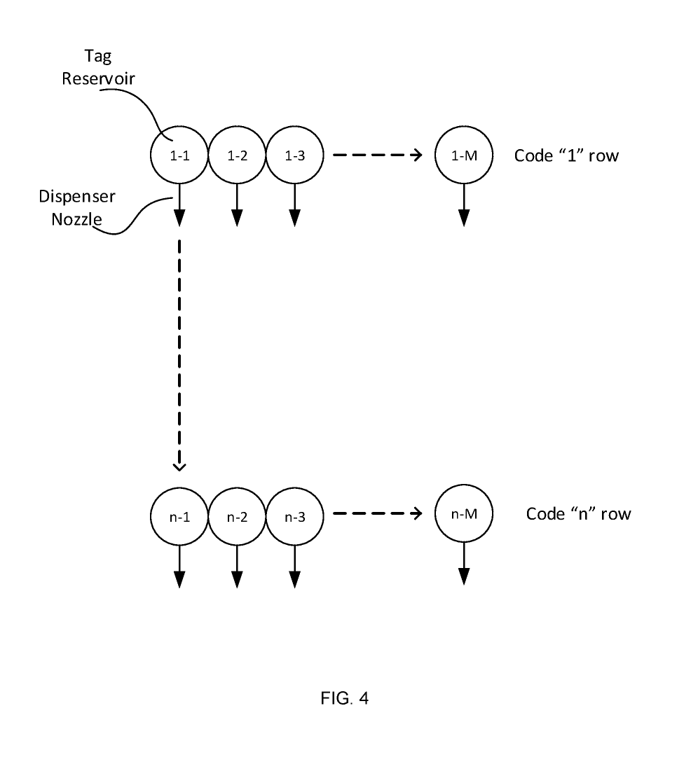

FIG. 4 is a diagram illustrating an embodiment of a system for depositing tags. In the example shown, the reservoirs (e.g., tag reservoir 1-1, tag reservoir 1-2, tag reservoir 1-3, tag reservoir 1-M, tag reservoir n−1, tag reservoir n−2, tag reservoir n−3, tag reservoir 1-M, etc.) are arranged in a row with the number of reservoirs corresponding to the desired number of columns in the final array. This structure represents a single code row. This reservoir row structure is repeated until the number of rows is equal to the desired number of codes. The dispensing of coded tags from a desired reservoir occurs when the reservoir moves to the desired spatial position of an N×M code matrix. This solution provides a path to serialize and individually identify objects by applying tags with a multiple number (n) of code signatures and arranging them in a pre-determined array (code matrix) of N rows and M columns. One or more tags are applied at each code matrix location dependent on issues such as cost, ease and speed of application, ease and speed of readout, error correction requirements and statistical confidence levels required for object identification. Additionally, no tags may be applied at various locations within the code matrix with their absence during readout considered part of the overall identifying code matrix; this would increase the number of available code matrices for a given number of tag codes.

The tags of a single code are placed into reservoirs with individually activated dispensing nozzles. The tags may be dry and rely on previously-applied adhesives to adhere to the object, such as in a laminate label structure; or rely on another method of adherence inherent in the object, such as static electricity or some pre-existing ‘sticky’ condition that offers sufficient bonding strength, the strength of which is dependent on the nature of the field-use requirements for the tagged object. In some cases, dry tags are applied using a low-density airborne delivery mechanism that is able to deliver the low-density tags to a spatially confined area. For example, the low-density delivery mechanism spatially confines the delivery by a double-walled confinement nozzle (e.g., as in shown in FIG. 1). The tags may be suspended in an adhesive liquid that is dispensed along with the tags onto the object and relies on time, heat, UV-activation or other method of curing to establish a physical bond between the tag and object. The dispensing nozzle can operate as quickly as one cycle every 10 msec and is of the type appropriate to the carrier adhesive; for example, syringe, pipette, or needle valve.

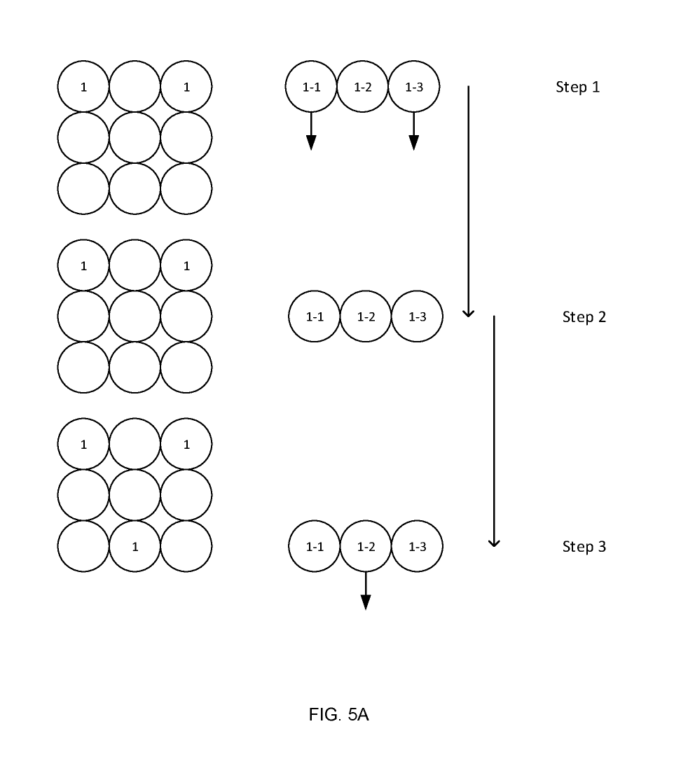

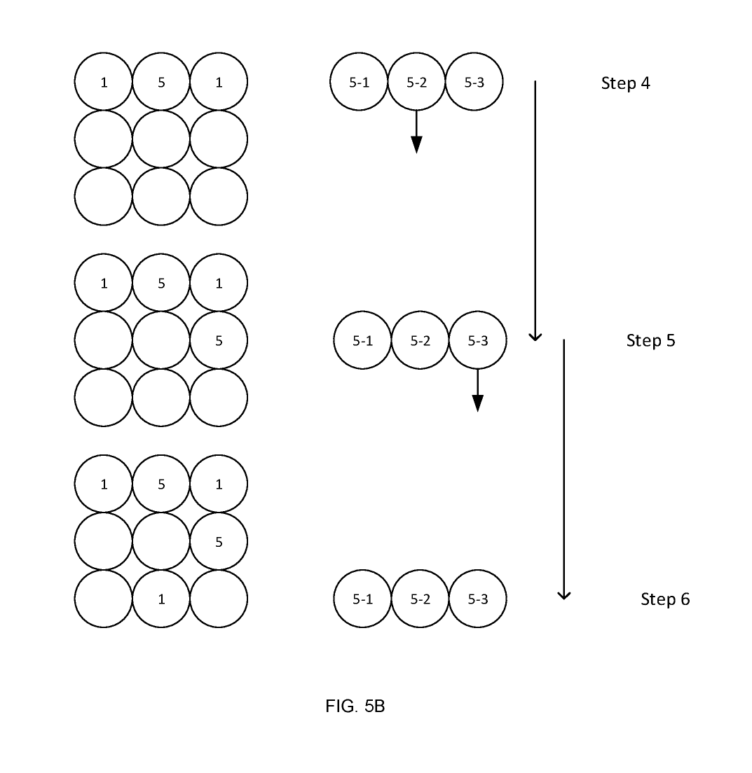

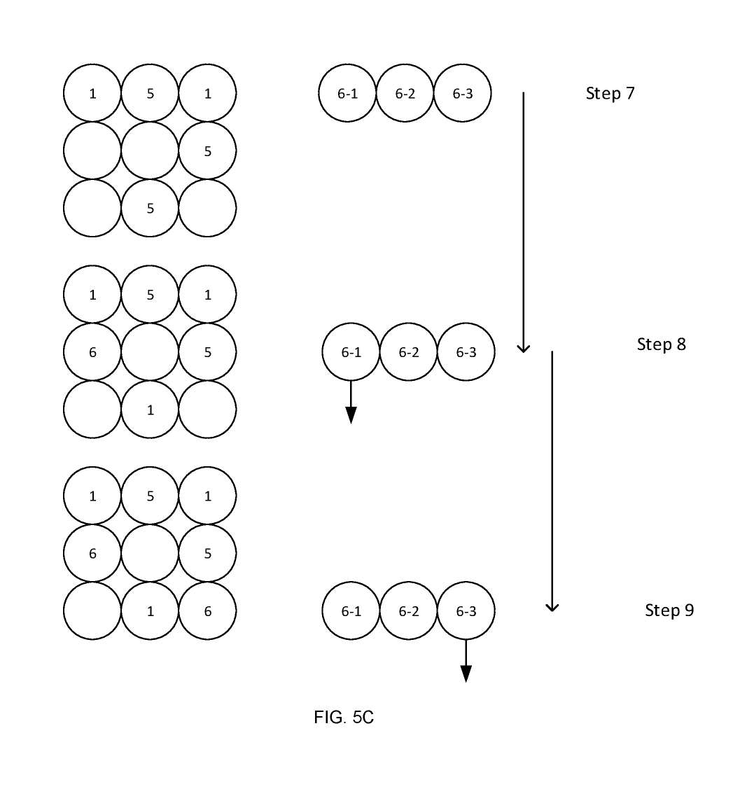

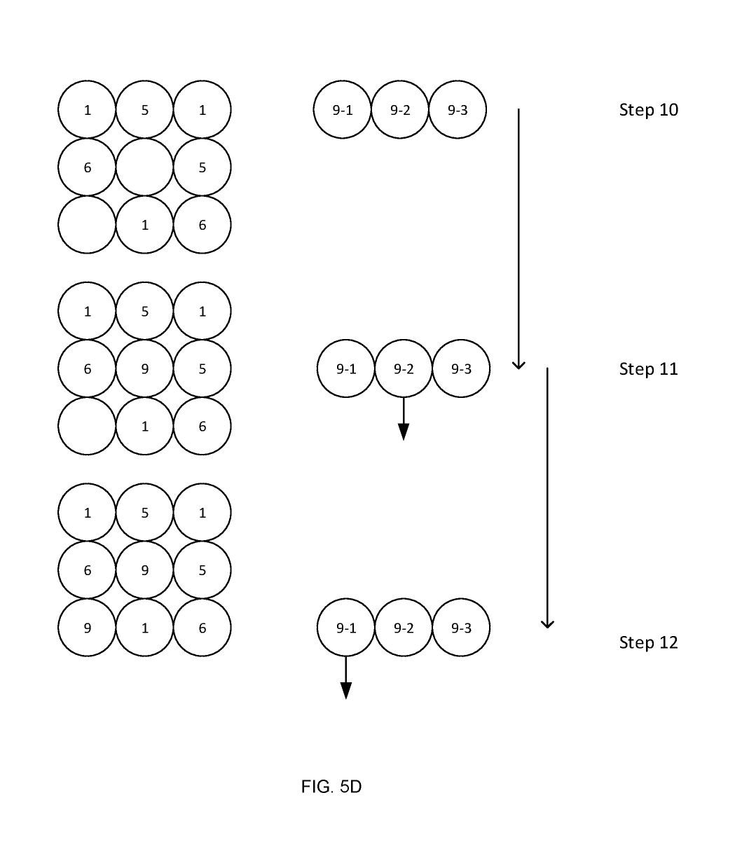

FIGS. 5A-D are diagrams illustrating an embodiment of a system for depositing tags. In the example shown, a code matrix is generated using a 3×3 matrix and 4 tag codes (e.g., using codes 1, 5, 6, and 9). The number of steps required to apply the code matrix depends on the number of rows and number of codes; in this example, it is 12. The number of steps could be reduced by excluding movement to rows where an active code is not applied. The process (shown as Steps 1 through Step 3 in FIG. 5A) starts by aligning reservoir row 1 to the position on the object where the first row of the code matrix is to be located. A fiducial mark applied to the object, and/or an existing physical reference point, such as the edge or corner of a label, may be used to assist in initial alignment of the reservoir row dispenser nozzles relative to the object.

In some cases, it may be desirable to not apply a fiducial mark. One example might be when marking a small item (e.g., an IC) that is smaller than the reader field-of-view. It may also be difficult or undesirable for a customer to add any extraneous marks to the item or label. Eliminating the fiducial mark however may reduce the number of possible code matrices available. For a rectangular having 2-fold symmetry or square code matrix having 4 possible orientations, the lack of a fiducial could reduce the number of unique code matrices available by the same factor of 4. Alternately if a 5-way rotational symmetry was used, a blank slice could act as an angular fiducial and the order of codes could start clockwise (or counterclockwise) from the blank slice.

The reader may either be a whiskbroom, pushbroom or snapshot hyperspectral or multispectral imager. The reader images the tagged region and collects spatial and spectral information on the microparticles. It may also collect information from fiducials, e.g., lines delineating the array members' boundary locations.

A consensus code is deciphered per array element and a “word” is retrieved comprising of codes and their location in the array. In some embodiments, a similar scheme can operate where instead of codes comprised of rugate peaks—for example, codes made of different Fabry Perot fringes (different effective thicknesses of the tags) are used.

A similar scheme can operate where instead of rugate peaks distributed across slots, “colored” rugate reflections are created by concentrating reflections in one relatively wide spectral band, thereby making the tags readable by a standard RGB (or multispectral) camera (e.g., a cellphone camera). The camera then captures an image of the tagged array and via an app recovers the encoded “word”. The app may contact a remote database—for example, in the cloud, and retrieve relevant information, such as the identity or provenance of the object referenced by the “word”.

To reduce tag readout errors, the design of the reservoir application system should minimize or prevent mixing or overlap of different tag-code populations between one code matrix location and another. This can be achieved for example by spraying very closely to the target or by applying a spatially-separated droplet of tag-bearing adhesive liquid.

Code matrix cell boundaries may be (i) printed on the substrate (e.g., circles or squares); (ii) be given as distances from a printed or otherwise patterned feature or fiduciary on the substrate; or ii) be decided by the tag-reader decoder by performing a cloud analysis of the tags and their positions—for example by fitting a Gaussian density distribution to the various clouds of encoded tags. In that case, tag population overlap may be tolerable to some extent. Stray tags will be ignored (up to a certain density) if they do not appear to be part of the a priori known density distributions.

The reservoir dispensers of code 1 are activated at the required locations (in this example, at locations 1-1 and 1-3 in step 1 of FIG. 5A). The reservoir 1 row moves to the second row of the Code Matrix where the reservoir 1 dispensers are not activated in this example. And finally, the process is repeated for the third row of the code matrix by applying code 1 tags at position 1-2 (step 3 in FIG. 5A). Next, the code 5 reservoir row is aligned with the first row of the code matrix and the process is repeated (e.g., steps 4-6 in FIG. 5B). Next, the code 6 row is aligned with the first row of the code matrix and the process is repeated (e.g., steps 7-9 in FIG. 5C). Next, the code 9 row is aligned with the first row of the code matrix and the process is repeated (e.g., steps 10-12 in FIG. 5D). At the end of the process, the desired code matrix is complete.

In some embodiments, all reservoir rows are located at a single application station where objects undergoing serialization are placed and the code matrix is completely applied before the object is moved.

In some embodiments, the reservoir rows are located at different application stations along the path of applying code matrices to serialized objects (e.g., a conveyor belt). Each single station applies a single code and the full code matrix is formed after multiple object stops at multiple locations. This arrangement allows for parallel application of tags to multiple objects.

In some embodiments, single reservoirs of each tag code are arranged on a selector—for example, a circular stage “revolver” type. The tag selector in turn is attached to an XY stage. All together these represent a code matrix application station. When an object is placed under the code matrix application station, the first required code reservoir is placed in the active position, the nozzle activated and is raster-scanned across the code matrix. The next code is selected and the process is repeated until the full matrix is complete.

In some embodiments, the dispensing nozzles are connected to the outputs of multichannel selector valves. The number of selector valves is equal to the total number of positions in the code matrix and each selector valve corresponds to a particular location in the code matrix. The number of input channels to each selector valve is equal to the total number of tag codes used to create the code matrix. The number of input channels to each selector valve is equal to the total number of tag codes used to create the code matrix. Input channels are connected to the corresponding pressurized reservoirs containing tags suspended in the carrier liquid. Alternatively, input channels can be connected to non-pressurized reservoirs via a transfer pump. During imprinting of the code matrix, each nozzle is connected to the desired tag code reservoir via the selector valve and all code matrix locations are deposited simultaneously. In one configuration the code selection can be done electronically. In another configuration code selection can be done manually.

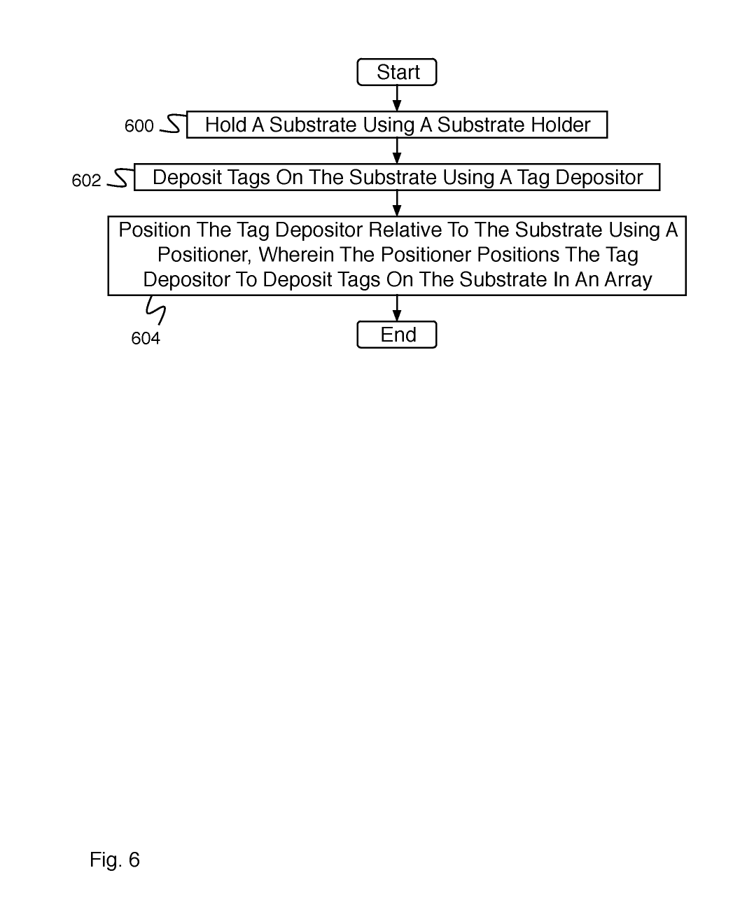

FIG. 6 is a flow diagram illustrating an embodiment of a process for depositing tags in an array. In some embodiments, the process of FIG. 6 is executed by the system of FIG. 1. In the example shown, in 600, a substrate is held using a substrate holder. In 602, tags are deposited on the substrate using a tag depositor. In 604, the tag depositor is positioned relative to the substrate using a positioner, wherein the positioner positions the tag depositor to deposit tags on the substrate in an array.

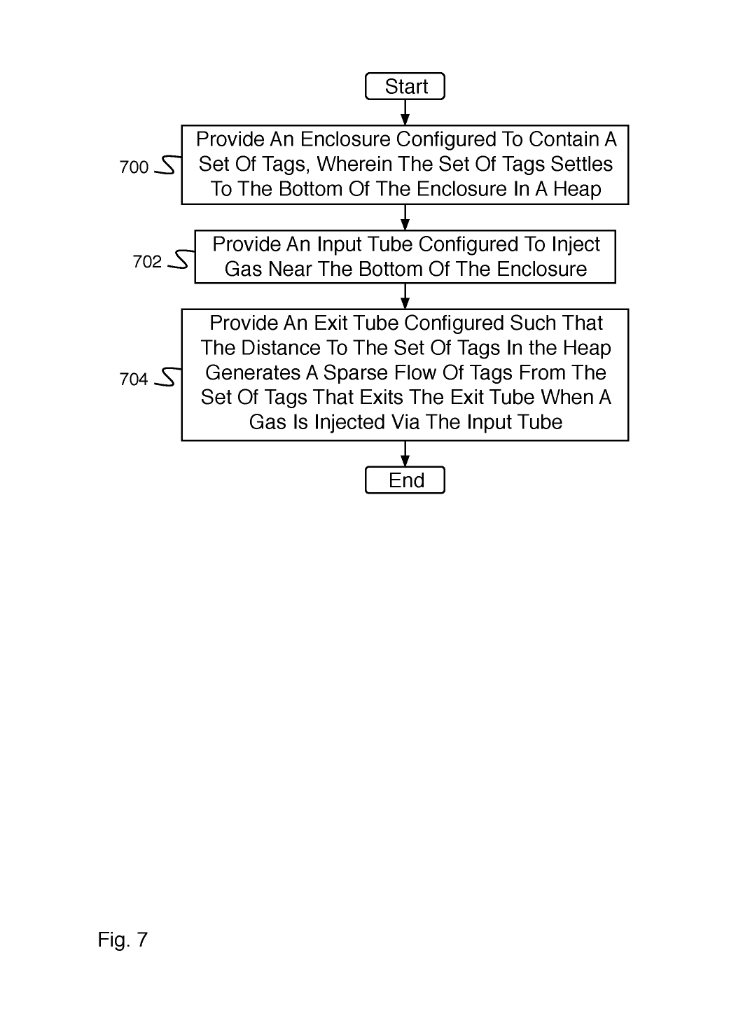

FIG. 7 is a flow diagram illustrating an embodiment of a process for sparse dispersion of tags. In some embodiments, the process of FIG. 7 is executed by the system of FIG. 2. In the example shown, in 700, an enclosure configured to contain a set of tags is provided, wherein the set of tags settles to the bottom of the enclosure in a heap. In 702, an input tube is provided configured to inject gas near the bottom of the enclosure.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for depositing tags in an array, comprising:
a substrate holder configured to hold a substrate;
a tag depositor configured to deposit tags on the substrate; and
a positioner configured to position the tag depositor relative to the substrate, wherein the positioner positions the tag depositor to deposit tags on the substrate in an array.

2. The system of claim 1, wherein the tags comprise optical interference filters.

3. The system of claim 2, wherein the optical interference filters comprise rugate filters.

4. The system of claim 2, wherein the optical interference filters comprise etched porous silicon filters.

5. The system of claim 1, wherein the tags comprise particles of less than 100 micrometers with embedded optically readable codes.

6. The system of claim 1, wherein the array comprises an orthogonal array, a non-orthogonal array, a line, a circle, a curve, a freeform curved line, or a two-dimensional array.

7. The system of claim 1, wherein the substrate holder comprises a belt.

8. The system of claim 7, wherein the belt moves.

9. The system of claim 1, further comprising a tag reservoir coupled to the tag depositor.

10. The system of claim 9, wherein the tag reservoir stores a plurality of tags of a single code.

11. The system of claim 9, wherein the tag reservoir comprises one of a plurality of tag reservoirs, wherein a coupling to the tag depositor is switchable between the plurality of tag reservoirs.

12. The system of claim 11, wherein a second tag reservoir of the plurality of tag reservoirs comprises tags of a second code.

13. The system of claim 1, wherein the tag depositor comprises one of a plurality of tag depositors.

14. The system of claim 13, wherein the plurality of tag depositors are arranged in a linear array.

15. The system of claim 1, wherein the tag depositor comprises a syringe, a pipette, or a needle valve.

16. The system of claim 1, wherein the tag depositor comprises a system for sparse dispersion of tags.

17. The system of claim 16, wherein the system for sparse dispersion of tags comprises:
an enclosure configured to contain a set of tags, wherein the set of tags settles to a bottom of the enclosure in a heap;
an input tube configured to inject gas near the bottom of the enclosure;
an exit tube configured such that a distance to the set of tags in the heap generates a sparse flow of tags from the set of tags that exits the exit tube when a gas is injected via the input tube.

18. A method for depositing tags in an array, comprising:
holding a substrate using a substrate holder;
depositing tags on the substrate using a tag depositor; and
positioning the tag depositor relative to the substrate using a positioner, wherein the positioner positions the tag depositor to deposit tags on the substrate in an array.

19. A system for sparse dispersion of tags, comprising:
an enclosure configured to contain a set of tags, wherein the set of tags settles to a bottom of the enclosure in a heap;
an input tube configured to inject gas near the bottom of the enclosure;
an exit tube configured such that the distance to the set of tags in the heap generates a sparse flow of tags from the set of tags that exits the exit tube when a gas is injected via the input tube.

20. A method for sparse dispersion of tags, comprising:
providing an enclosure configured to contain a set of tags, wherein the set of tags settles to a bottom of the enclosure in a heap;
providing an input tube configured to inject gas near the bottom of the enclosure;
providing an exit tube configured such that the distance to the set of tags in the heap generates a sparse flow of tags from the set of tags that exits the exit tube when a gas is injected via the input tube.
